(19) United States
(12) Patent Application Publication
(10) Pub. No.: US 2006/0132086 A1
(43) Pub. Date: Jun. 22, 2006

(54) Power source selection

(75) Inventors: Michael E. Altenburg, Beaverton, OR (US); Steven S. Varnum, Tigard, OR (US); Bruce W. Rose, Aloha, OR (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/019,920

(22) Filed: Dec. 21, 2004

(51) Int. Cl. H02J 7/00

(52) U.S. Cl. 320/106

(57) ABSTRACT

A power source selection approach of one embodiment includes a voltage monitor to monitor a system supply voltage and to assert a droop signal if the system supply voltage droops below a threshold voltage. A power source selector is responsive to assertion of the droop signal to configure at least one power source, such as, for example, a battery pack, to attempt to provide sufficient voltage such that a system supply voltage is raised above the threshold voltage.

### BACKGROUND

An embodiment of the present invention relates to the field of electronic systems and, more particularly, to an approach for power source selection.

Electronic circuitry such as a micro-controller may be used in some battery-powered electronic systems, or other systems that may be powered by an alternative power source, to monitor the status of one or more battery packs or other power sources and select an appropriate power source. For such systems, if the monitoring/selection circuitry is not able to respond quickly enough to a power source change to select a battery pack or other power source before the system voltage rail droops below a certain level, the system may crash.

### BRIEF DESCRIPTION OF THE DRAWINGS

The present invention is illustrated by way of example and not limitation in the figures of the accompanying drawings in which like references indicate similar elements, and in which:

FIG. 1 is a schematic diagram illustrating a power delivery sub-system of an electronic system that uses power switches on a motherboard to select between multiple battery packs and control circuitry to control the battery pack selection.

FIG. 2 is a schematic diagram of a conventional battery pack that may be used in the system of FIG. 1.

FIG. 3 is a schematic diagram of a modified battery pack including integrated selection logic that may be used for one embodiment.

FIG. 4 is a schematic diagram illustrating a power delivery sub-system of an example embodiment using a novel voltage monitor and battery selector and incorporating one or more battery packs according to FIG. 3.

FIG. 5 is a schematic diagram illustrating a voltage monitor and combinatorial battery selection circuit of an example embodiment that may be used in the system of FIG. 2.

FIG. 6 is a block diagram of an example system that may advantageously implement the power source selection approach of one or more embodiments.

FIG. 7 is a flow diagram showing a method of one embodiment for battery pack or other power source selection.

### DETAILED DESCRIPTION

A method and apparatus for power source selection are described. In the following description, particular components, circuits, systems, power sources, battery types, battery configurations, etc. are described for purposes of illustration. It will be appreciated, however, that other embodiments are applicable to other types of components, circuits, systems, power sources and/or battery types and/or configurations, for example.

References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” or “for one embodiment” does not necessarily refer to the same embodiment, although it may.

Embodiments of the invention may be implemented in one or a combination of hardware, firmware, and software. Embodiments of the invention may also be implemented in whole or in part as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

For one embodiment, a voltage monitor is capable of monitoring a system supply voltage, also referred to herein as a system voltage rail, and asserting a droop signal if the system supply voltage droops below a threshold voltage. An energy or power source selector is responsive to assertion of the droop signal to configure at least one power source, such as a battery pack, for example, to attempt to provide a system supply voltage higher than the threshold voltage. For some embodiments, the power source selector may configure all available power sources to attempt to raise the system supply voltage above the threshold voltage. One example reason the at least one power source may not be able to raise the system supply voltage above the threshold voltage if the power source being configured to provide the system supply voltage has been substantially discharged or otherwise substantially depleted.

For purposes of illustration, while the power source for many of the example embodiments described herein includes one or more battery packs, for other embodiments the power source may include one or more fuel cells, photovoltaic cells and/or uninterruptible power supplies, for example. Still other types of power sources may be used for other embodiments. Details of these and other embodiments are provided in the description that follows.

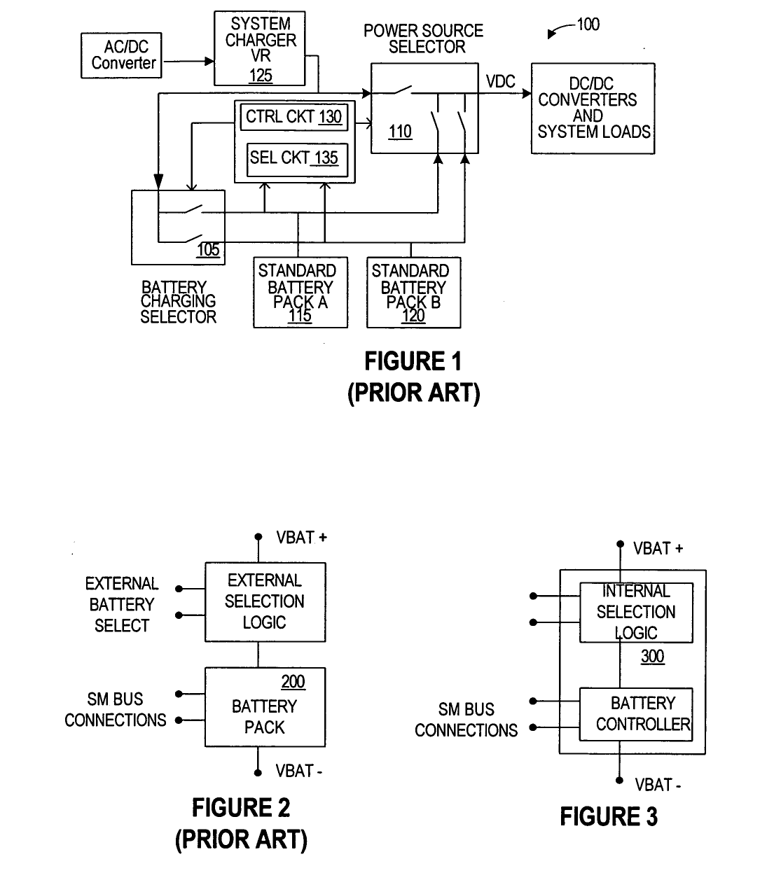

FIG. 1 is a block diagram of a portion of a conventional system 100 that implements power switches 105 and 110 on a motherboard (not shown) and includes multiple battery packs 115 and 120. The system 100 may be a laptop or notebook computer system or another type of mobile electronic system, for example. One or both of the battery packs 115 and/or 120 may be similar to the example battery pack 200 of FIG. 2.

The power switches 105 and 110, which may be referred to as isolation power switches, (shown as a Battery Charging Selector 105 and a Power Source Selector 110 in FIG. 1) are provided between the battery packs 115 and 120 and the system power rail, typically provided by a system charger voltage regulator (VR) 125, to selectively connect and disconnect the battery packs 115 and 120, and also to enable the system 100 to continuously monitor the battery pack voltages. For the example system 100 of FIG. 1, the power switches may be controlled by a micro-controller or other control circuitry 130.

In operation, a power source change for the system 100 may occur, for example, as a result of disconnecting an AC power source. As mentioned above, if the micro-controller 130 is not able to respond quickly enough to a power source change to select a battery pack, and the system voltage rail droops below a certain level, the system 100 may crash or otherwise be compromised. To avoid this situation, combinatorial battery selection circuitry 135 may be provided to monitor the battery pack voltages for the battery packs 115 and 120, and to select a battery pack if the micro-controller 130 is unable to do so.

FIG. 3 is a diagram of an alternative battery pack configuration 300 that may be used for some electronic systems. As shown in FIG. 3, in contrast to the conventional battery pack 200 of FIG. 2, the battery pack 300 may integrate selection control logic 305 that may be responsive to external battery select signals. In this manner, redundant components (such as the power switches mentioned above) may be eliminated, and power dissipation and area may be reduced. Further details of such battery packs may be found, for example, in a specification available from Intel Corporation, entitled “Narrow VDC Extended Battery Life (EBL) Technique Battery Pack Specification for Intel Customer Reference Boards,” December, 2003.

For the modified battery pack 300 of FIG. 3, the battery pack voltage may be more difficult to monitor because the power switches on the motherboard are not implemented, as mentioned above. For this reason, the approach used for the system of FIG. 1 to prevent system crashes due to voltage droop when the microcontroller cannot respond quickly enough to a power source change may not be feasible.

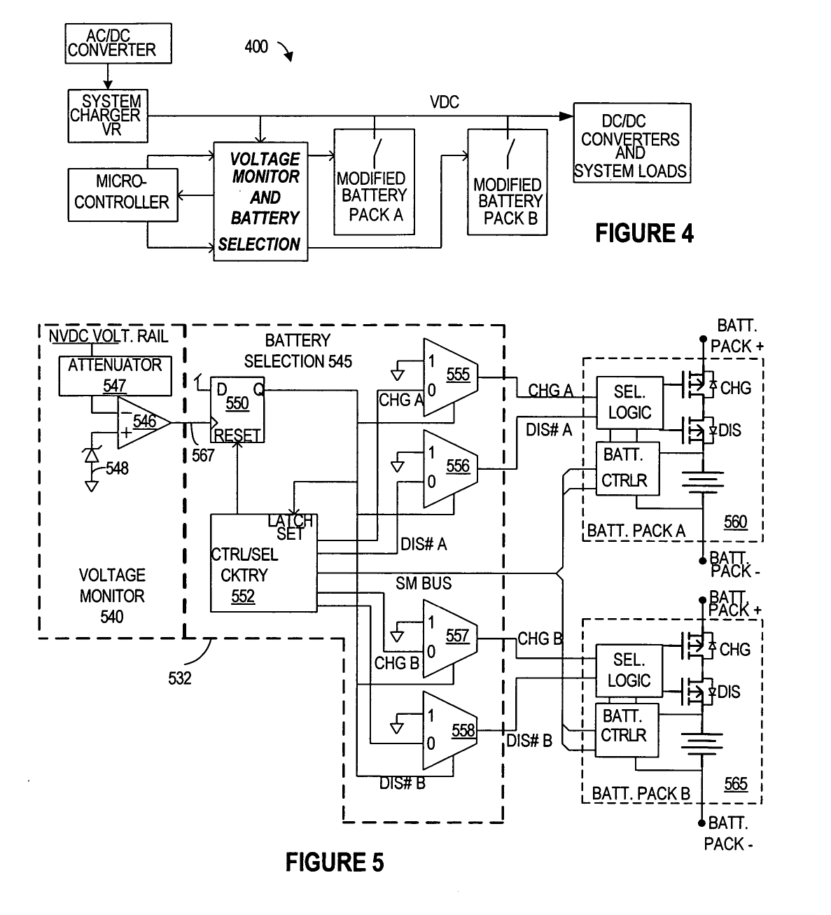

FIG. 4 is a block diagram of an example power delivery sub-system 400 of one embodiment that may be capable of enabling modified battery packs, such as battery packs similar to the battery pack of FIG. 3, in the event that a micro-controller or other logic or circuitry is unable to do so. The sub-system 400 includes one or more modified battery packs 415 and/or 420 that may be implemented in a similar manner to the battery pack 300 of FIG. 3. As shown in FIG. 4, a micro-controller or other control logic or circuitry 430 is provided to control battery pack selection. The system 400 also includes a novel voltage monitor and battery selection module 432.

FIG. 5 is a schematic diagram of an example circuit 532 that may be used to provide the voltage monitor and battery selection circuit 432 in the power delivery subsystem 400 of FIG. 4. The circuit 532 includes a voltage monitor circuit 540 and a battery or other power source selection circuit 545.

The voltage monitor circuit 540 includes a voltage comparator 546 coupled to receive a reference voltage at a first input and has a second input coupled to monitor an attenuated version of the voltage of a system voltage rail via an attenuator 547 for one embodiment. The system voltage rail may be provided, for example, by an external AC power source or a battery pack. For one embodiment, the system voltage rail is a Narrow VDC system voltage rail as described in the above-referenced specification, and elsewhere in publicly available documentation. For another embodiment, the system voltage rail may be according to a different power delivery approach. The attenuator 547, where used, may have an attenuation factor anywhere in the 0 to 1 range. If the attenuation factor is 1, then the attenuator 547 does not alter the voltage being monitored. It may be desirable, however, to have an attenuation factor less than 1 but greater than 0 for some embodiments because the voltage rail being monitored is the highest voltage in the system and it may be easier to measure if it is at a lower level.

The reference voltage of one embodiment may be provided by a bandgap reference, a zener diode 548, or a resistor divider, for example. Where a resistor divider is used, it may be connected to receive a stable voltage. Alternatively, the resistor divider may be coupled to receive a variable voltage if a variation in the threshold voltage is desired due to, for example, a change in temperature of the battery pack. Other approaches to providing a reference voltage are within the scope of various embodiments.

The battery selection circuit 545 of one embodiment includes a latch 550, a battery selection micro-controller or other control/selection circuitry 552, and multiplexers 555-558. A clock input of the latch 550 is coupled to receive an output of the voltage comparator 546, a reset input of the latch is coupled to receive a reset latch output signal from the control/selection circuitry 552 and another input of the latch 550 is tied high. An output of the latch 550 is coupled to select inputs of each of the multiplexers 555-558 and to a latch set input of the ciruitry 552 as shown.

The micro-controller or other control/selection circuitry 552 provides charge and discharge control output signals shown as Chg A (charge battery pack A), Dis# A (discharge battery pack A), Chg B (charge battery pack B) and Dis# B (discharge battery pack B) for battery packs A and B, 560 and 565, respectively. Battery packs 560 and 565 may correspond to the battery packs A and B of the power delivery sub-system of FIG. 4.

Each of the output signals Chg A, Dis# A, Chg B and Dis# B is provided over a respective signal line coupled to one of the multiplexers 555-558 as shown. The circuit 552 also provides a system management (SM) bus output coupled to inputs of the battery controllers of each of the battery packs 560 and 565. While two battery packs are shown in FIGS. 4 and 5, it will be appreciated that a different number of battery packs may be included for other embodiments. For such embodiments, it will be appreciated that a different number of multiplexers and a different number of charge and/or discharge output signals from the micro-controller may also be used.

Referring to FIGS. 4 and 5, in operation, the voltage comparator 546 monitors the system voltage rail and compares an attenuated version of it to the reference voltage (alternatively referred to herein as a threshold voltage) provided by the reference voltage source 548. For one embodiment, the reference voltage may be selected such that a comparator toggles below an acceptable operating voltage range of the system power rail, but above a level that may allow the system to fail and/or cause damage to the batteries 560 and/or 565. The particular reference voltage selected may depend on the power delivery system in which it is used, the latency of the voltage monitor and battery selection module, the temperature of the battery pack, the battery chemistry technology and/or other system features.

If the attenuated system rail voltage droops below the reference voltage, e.g. because all of the power sources have been disconnected and the control/selection circuit 552 has not yet selected a power source, the voltage comparator 546 asserts a droop signal at an output of the voltage comparator 567. Assertion of the droop signal clocks the latch 550 causing the latch 550 to be set and an output signal from the latch 550 to be asserted.

Assertion of the latch output configures the batteries 560 and 565 to the system supply rail through diode connections as shown in FIG. 5 (represented as switches in FIG. 4) for one embodiment. In this manner, the batteries 560 and 565 provide power to the system, but do not charge or discharge each other. It is desirable for some embodiments for the voltage provided by the battery pack(s) to be at least sufficient to keep the attenuated voltage rail value from drooping below the reference voltage, but the voltage may be higher. If the voltage provided by the battery pack(s) is not sufficient to keep the attenuated voltage rail value from drooping below the reference voltage, then other circuits in the system may react in a manner that they normally react when the battery rail voltage droops due to low battery pack voltage.

For the particular embodiment of FIG. 5, assertion of the latch 550 output in response to detecting a system voltage rail droop causes select inputs of each of the multiplexers 555-558 to be asserted. Because the “1” input of each of the multiplexers 555-558 is tied low as shown in FIG. 5, and because the discharge A and discharge B signals are active low, the discharge A (Dis# A) and discharge B (Dis# B) signals are asserted in response to the select signals being asserted for the embodiment shown in FIG. 5. The battery pack select logic 570 and 575 of the respective battery packs is then responsive to assertion of the discharge A and discharge B signals to configure the battery packs 560 and 565 as described above.

The output of the latch 550 is also coupled to a latch set input signal of the micro-controller or other control/selection circuit 552, such that when the output of the latch is asserted, an indication is provided to the micro-controller 552 that the batteries 560 and 565 need to be intelligently selected. Then, at a convenient time, the micro-controller 550 may configure the batteries 560 and/or 565 according to battery configuration logic provided on the micro-controller. Upon completion of the configuration/selection, the micro-controller 552 may assert a reset latch signal to reset the latch 550.

While two battery packs are described as being coupled to provide system power in connection with the example embodiments illustrated in FIGS. 4 and 5, for other embodiments, a different number of battery packs and/or fewer than all available battery packs or other power sources may be enabled in response to detecting a system voltage rail droop. Further, while the example embodiments of FIGS. 4 and 5 have been described with reference to the battery pack of FIG. 3 including integrated selection logic, another type of battery pack, including, for example, the battery pack of FIG. 2, or another type of power source (e.g. a fuel cell, photovoltaic cell, etc., with internal or external selection logic, may be used for other embodiments and/or benefit from the power source selection approach of various embodiments.

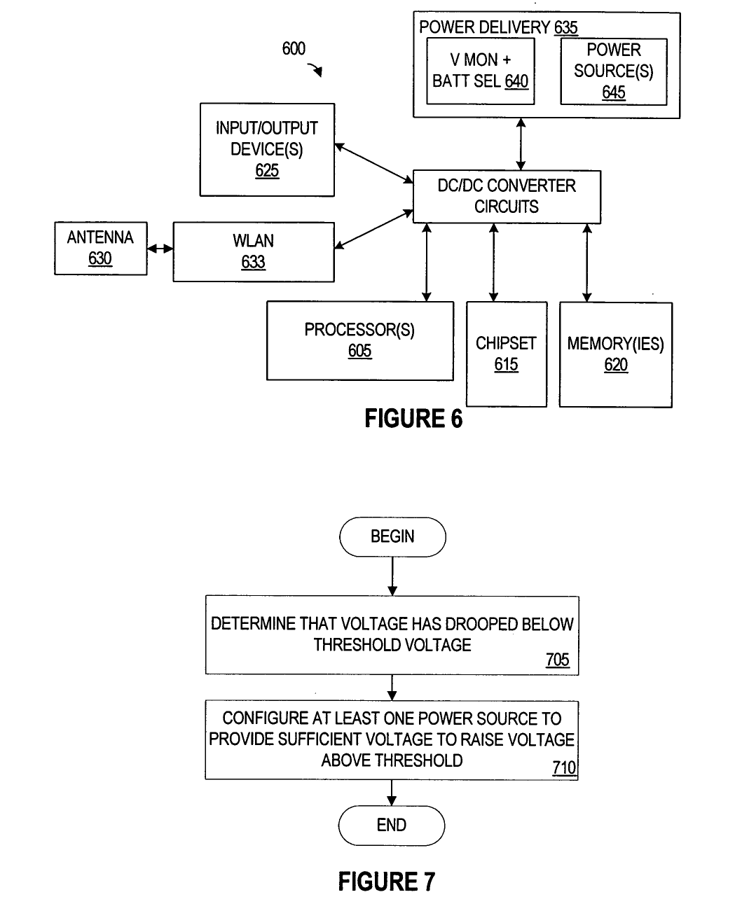

FIG. 6 is a block diagram of an example system 600 in which the power selection approach of one or more embodiments may be advantageously used. The system 600 may include one or more processors 605 coupled to a bus 610, a chipset 615 also coupled to the bus 610, one or more memories 620, and one or more input and/or output devices 625. The system 600 may also include an antenna 630 and a networking component such as, for example, a wireless local area network (WLAN) component 633.

The processor 605 may be a micro-processor including a single core or multiple cores, a digital signal processor, an embedded processor or a graphics processor, for example. The bus 610 may be a point-to-point bus, a switched fabric or another type of bus. The system 600 may be a mobile computing device such as a laptop or notebook computer, a personal digital assistant or the like. Alternatively, the system 600 may be another type of electronic system such as, for example, a wireless telephone. Other types of electronic systems are within the scope of various embodiments.

The system 600 is powered by a power delivery subsystem 635, which may be similar in configuration and operation to the power delivery subsystem 400 of FIG. 4 including a voltage monitor and power selection module 640, which may be substantially similar in configuration and/or operation to the voltage monitor and power selection module 532 of FIG. 5. Power sources 645 within the power delivery sub-system may include one or more battery pack(s), photovoltaic cell(s), fuel cell(s), uninterruptible power source(s) or other type of power source.

FIG. 7 is a flow diagram illustrating a power source selection method of one embodiment. At block 705, it is determined that a system voltage rail or other voltage has drooped below a reference or threshold voltage. At block 710, a power source selection module is responsive to the determination at block 705 to configure at least one power source to attempt to provide at least sufficient voltage to raise the system voltage rail or other voltage above the threshold voltage. For some embodiments, at block 710, the power source selection module is responsive to the detection of a power rail droop to enable all accessible power sources to attempt to raise the system voltage.

It will be appreciated that, for other embodiments, the method may include additional actions.

Thus, various embodiments of a method and apparatus and system for battery pack selection are described. In the foregoing specification, the invention has been described with reference to specific example embodiments thereof. It will, however, be appreciated that various modifications and changes may be made thereto without departing from the broader spirit and scope of the invention as set forth in the appended claims. For example, while a specific implementation of a battery selection circuit is described, it will be appreciated that other types of circuits, logic, software and/or firmware that perform a similar function may be used for other embodiments. The specification and drawings are, accordingly, to be regarded in an illustrative rather than a restrictive sense.

What is claimed is:

1. An apparatus comprising:
a voltage monitor to monitor a system supply voltage and to assert a droop signal if the system supply voltage droops below a threshold voltage; and
a power source selector responsive to assertion of the droop signal to configure at least one power source to attempt to provide sufficient voltage to raise a system supply voltage above the threshold voltage.

2. The apparatus of claim 1 wherein the power source selector is to configure at least one battery pack having one of integrated and external selection logic to receive a selection control signal from the power source selector.

3. The apparatus of claim 1 wherein the voltage monitor comprises a voltage comparator.

4. The apparatus of claim 3 wherein the power source selector comprises:
a latch coupled to an output of the voltage comparator; and
at least one multiplexer coupled to an output of the latch,
the latch being responsive to assertion of the droop signal to cause the at least one multiplexer to output a discharge signal to cause the power source to be configured to attempt to provide the sufficient voltage.

5. The apparatus of claim 4 further comprising a control circuit to control battery selection, the control circuit being coupled to the latch, the latch being responsive to assertion of the droop signal to cause the control circuit to control power source selection.

6. The apparatus of claim 1 wherein the system supply voltage is a narrow VDC system supply voltage.

7. The apparatus of claim 6 wherein the at least one power source includes one of integrated and external selection logic.

8. The apparatus of claim 1 wherein the at least one power source includes one of a battery, a fuel cell, a photovoltaic cell and an uninterruptible power supply.

9. An apparatus comprising:
a voltage monitor to monitor a voltage of a system supply rail and to assert a droop signal responsive to the voltage of the system supply rail drooping below a threshold voltage; and
a battery pack selection module responsive to the droop signal to enable at least one battery pack.

10. The apparatus of claim 9 wherein
the battery pack selection module is responsive to the droop signal to enable all battery packs coupled to the battery pack selection module.

11. The apparatus of claim 10 wherein the battery packs includes one of integrated and external selection logic.

12. A method comprising:
detecting that a system supply voltage is below a threshold voltage; and
responsive to the detection, configuring at least one power source to attempt to provide sufficient voltage to raise the system supply voltage above the threshold voltage.

13. The method of claim 12 wherein
configuring at least one power source includes configuring at least one of a battery pack, a fuel cell, a photovoltaic cell and an uninterruptible power supply.

14. The method of claim 12 further comprising:
monitoring the system supply voltage.

15. The method of claim 14 wherein
detecting that a system supply voltage is below a threshold voltage includes comparing one of the system supply voltage and an attenuated version of the system supply voltage to a reference voltage.

16. The method of claim 15 wherein
configuring the at least one power source includes configuring at least one power source including integrated selection logic.

17. The method of claim 12 wherein configuring the at least one power source includes enabling all available power sources.

18. A system comprising:
a bus to communicate information;
a processor coupled to the bus to process instructions;
an antenna coupled to the bus to receive wireless data; and
a power delivery sub-system coupled to the bus to provide power to the system, the power deliver sub-system including
a voltage monitor to monitor a system rail voltage and to assert a droop signal if the system rail voltage drops below a threshold voltage;
at least a first power source, the first power source comprising one of a battery pack, a fuel cell, a photovoltaic cell and an uninterruptible power supply; and
a power source selector, the power source selector being responsive to the droop signal to enable the at least first power source.

19. The system of claim 18 wherein the power delivery sub-system further comprises:
at least a second power source, the second power source comprising one of a battery pack, a fuel cell, a photovoltaic cell and an uninterruptible power supply.

20. The system of claim 19 wherein
the power source selector is further responsive to the droop signal to enable both of the first and second power sources.

21. The system of claim 18 wherein
the voltage monitor includes a voltage comparator to compare the system voltage rail to the threshold voltage, the threshold voltage to be provided by one of a bandgap, a zener diode and a resistor divider.

22. The system of claim 21 wherein
the at least first power source is a battery pack including integrated selection logic.
